(19) United States
(12) Patent Application Publication
(10) Pub. No.: US 2005/0224736 A1
(43) Pub. Date: Oct. 13, 2005

(54) Oil return valve

(75) Inventor: Cui Lan Wang, Tai-Shan City (CN)

Correspondence Address: BACON & THOMAS, PLLC, 625 SLATERS LANE, FOURTH FLOOR, ALEXANDRIA, VA, 22314, US

(73) Assignee: SHINN FU CORPORATION, Lu Chu Hsiang (TW)

(21) Appl. No.: 10/819,161

(22) Filed: Apr. 7, 2004

(51) Int. Cl. F16L 55/02

(52) U.S. Cl. 251/121

(57) ABSTRACT

An oil return valve threaded into the casing of the hydraulic system of a hydraulic jack for controlling the flow rate of return oil is disclosed to have a tapered front eng engaged into an oil hole between the inner oil cylinder and outer oil cylinder of the hydraulic system so that rotating the oil return valve forwards/backwards relative to the casing causes variation of the oil passage for return oil between the outer oil cylinder and the inner oil cylinder.

### BACKGROUND OF THE INVENTION

(a) Field of the Invention

The present invention relates to an oil return valve for use in a hydraulic jack and more particularly, to an oil return valve, which has a tapered front tip extended from the screw rod-like body for controlling the flow rate of the oil passage for return oil.

(b) Description of the Prior Art

The oil return design of a conventional hydraulic jack uses an oil return valve (or called release valve or relief valve) to control return of hydraulic fluid from the inner cylinder (high-pressure chamber) to the outer cylinder (oil tank), for enabling the lift arm to be lowered to the former stand-by status. However, when opened the oil return valve, hydraulic fluid flows rapidly at a high flow rate to the outer cylinder, and the vehicle or other load falls with the lift arm to the bottom side at a high speed. Rapid falling of the load with the lift arm produces a high impact that may cause damage to the hydraulic system or injury to the operator.

### SUMMARY OF THE INVENTION

The present invention has been accomplished under the circumstances in view. It is one object of the present invention to provide an oil return valve, which can conveniently controlled to adjust the flow rate of return oil.

To achieve this and other objects of the present invention, the oil return valve is installed in the casing of the hydraulic system of a hydraulic jack and engaged into an oil hole in the casing between an inner oil cylinder and an outer oil cylinder and adapted to control the flow rate of return oil between the outer cylinder and the inner cylinder, the oil return valve comprising an outer thread threaded into an inner thread in the casing and a front tip suspended in the oil hole and peripherally confining with the periphery of the oil hole an oil passage between the outer oil cylinder and the inner oil cylinder, the oil passage being variable by rotating the oil return valve in the inner thread forwards/backwards.

### BRIEF DESCRIPTION OF THE DRAWINGS

FIG. 1 is a top view of the hydraulic system of a hydraulic jack constructed according to the present invention.

FIG. 2 is a sectional view taken along line A-A of FIG. 1.

FIG. 3 is an enlarged view of a part of the present invention, showing the closed status of the oil passage.

FIG. 4 is a sectional view taken along line B-B of FIG. 3 (return hydraulic fluid completely blocked).

FIG. 5 is similar to FIG. 3 but showing the oil passage partially opened.

FIG. 6 is a sectional view taken along line C-C of FIG. 5.

FIG. 7 is similar to FIG. 5 but showing the oil passage opened further wider.

FIG. 8 is a sectional view taken along line D-D of FIG. 7.

### DETAILED DESCRIPTION OF THE PREFERRED EMBODIMENTS

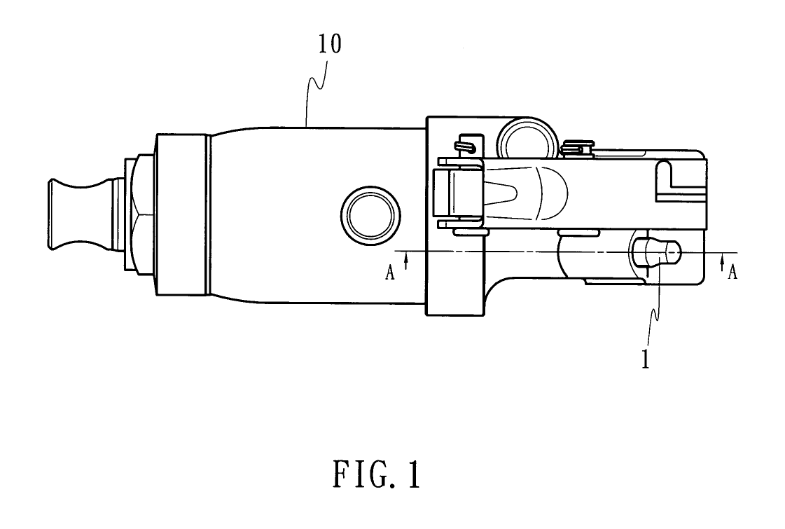

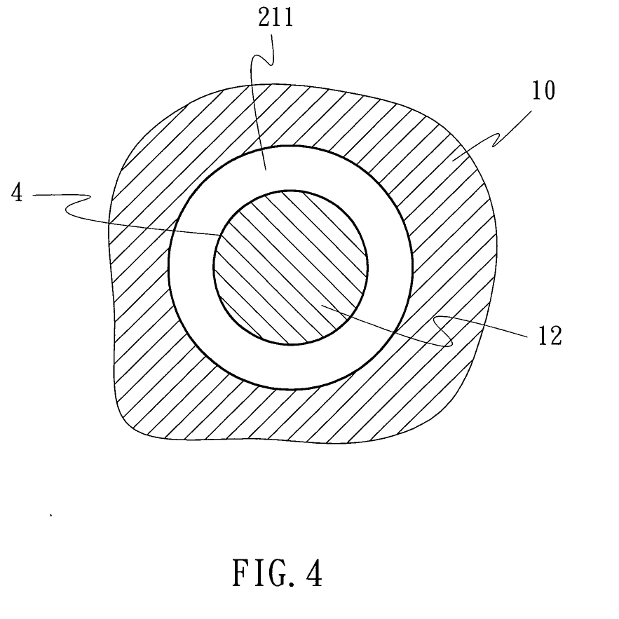

Referring to FIGS. 1˜3, an oil return valve 1 is shown used in the hydraulic system of a hydraulic jack 10. The oil return valve 1 is shaped like a rod member having an outer thread 11 threaded into the casing of the hydraulic system of the hydraulic jack 10, and a tapered front tip 12 axially engaged into a first oil hole 21, which extends from an internal oil cylinder 2 and is in fluid communication with a second oil hole 31 being extended from an outer oil cylinder (not shown).The peripheral wall of the first oil hole 21 and the outer surface of the tapered front tip 12 define an annular oil passage 4 (see FIGS. 4, 6, and 8) for the passing of return oil (hydraulic fluid). By means of rotating the oil return valve 1 relative to the casing of the hydraulic system of the hydraulic jack 10, the size of the annular oil passage 4 is relatively adjusted, and therefore the flow rate of return oil is controlled.

Referring to FIGS. 3 and 4, when fastened the oil return valve 1 tightly (i.e., rotated the oil return valve 1 forwards in the casing of the hydraulic system of the hydraulic jack 10 to the limit), the annular oil passage 4 is closed, and at this time the hydraulic jack 10 can be started to lift the load.

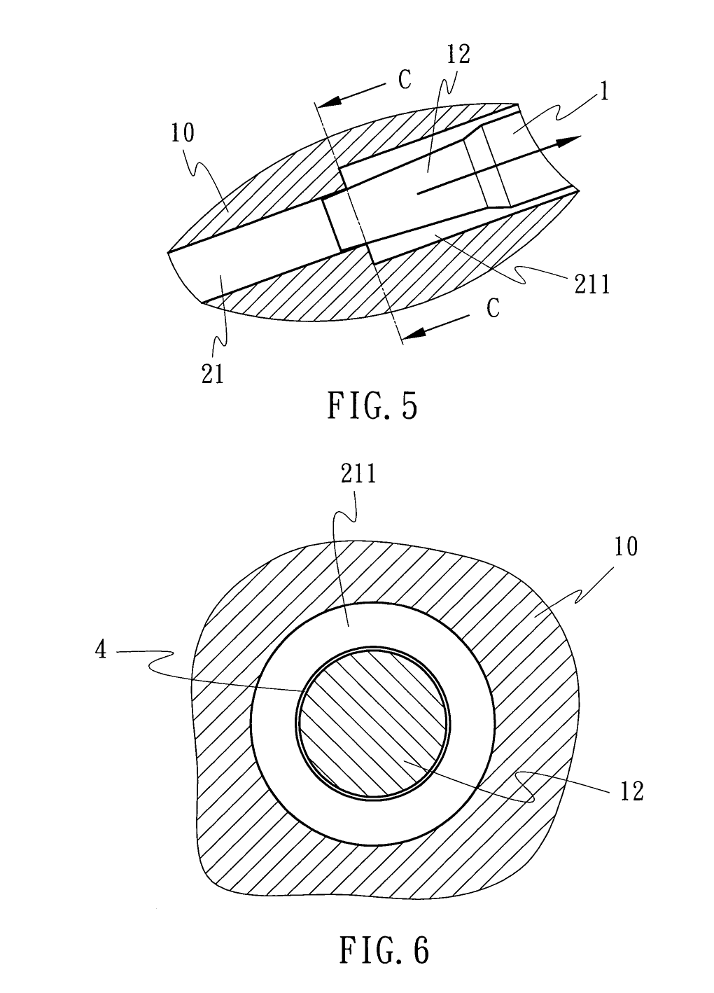

Referring to FIGS. 5 and 6, when wishing to lower the load to the bottom side after the work has been done, the oil return valve 1 is slightly rotated backwards to open the annular oil passage 4, allowing oil to pass. Because of low flow rate, the load is lowered at a low speed.

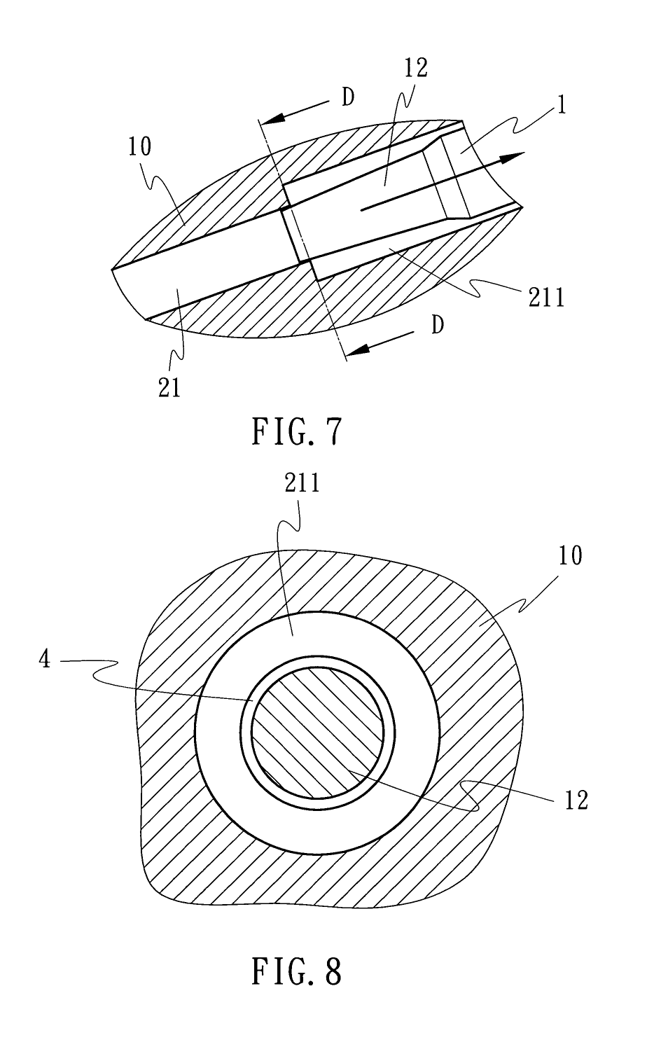

Referring to FIGS. 7 and 8, when rotated the oil return valve 1 further backwards to widen the annular oil passage 4, the flow rate of return oil is relatively increased, and the load is lowered at a relatively fast speed.

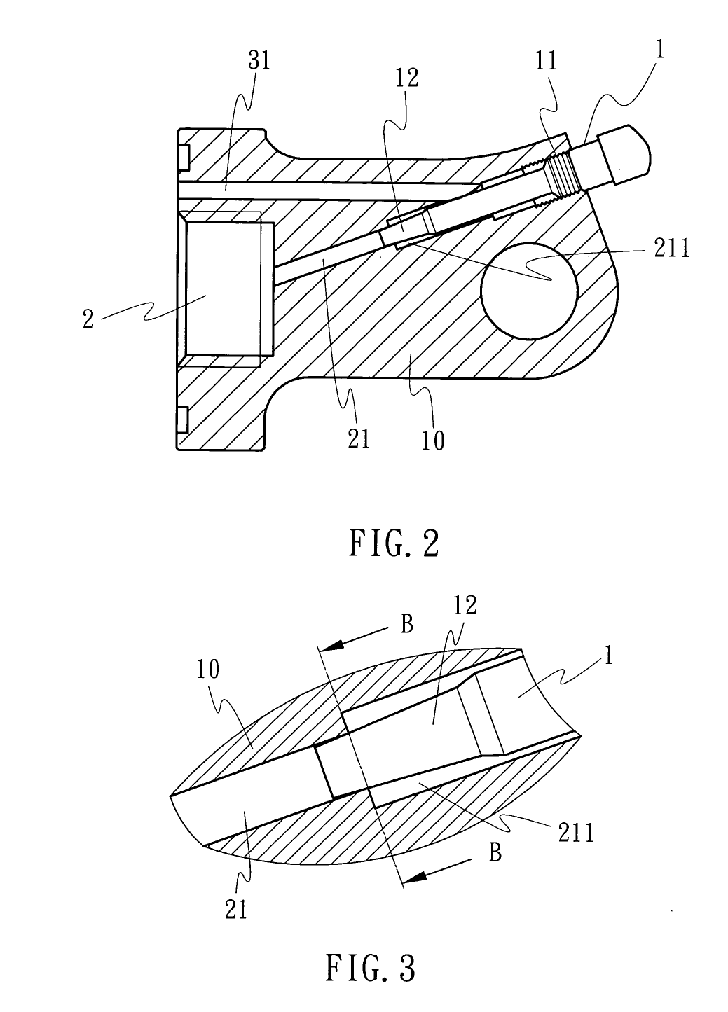

Referring to FIGS. 2˜8 again, the first oil hole 21 is preferably a stepped hole having a relatively greater diameter portion 211 connected to the second oil hole 31. The tapered front tip 12 of the oil return valve 1 extends through the relatively greater diameter portion 211 and is partially engaged into the relatively front smaller diameter portion of the first oil hole 21. By means of rotating the oil return valve 1 relative to the casing of the hydraulic system of the hydraulic jack 10, the oil passage 4 is relatively adjusted.

A prototype of oil return valve has been constructed with the features of FIGS. 1˜7. The oil return valve functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An oil return valve installed in the casing of the hydraulic system of a hydraulic jack and engaged into an oil hole in said casing between an inner oil cylinder and an outer oil cylinder and adapted to control the flow rate of return oil between said outer cylinder and said inner cylinder, the oil return valve comprising an outer thread threaded into an inner thread in said casing and a front tip suspended in said oil hole and peripherally confining with the periphery of said oil hole an oil passage between said outer oil cylinder and said inner oil cylinder, said oil passage being variable by rotating the oil return valve in said inner thread forwards/backwards.

2. The oil return valve as claimed in claim 1, wherein said oil hole is a stepped hole.
